(19) United States
(12) Patent Application Publication
(10) Pub. No.: US 2026/0348851 A1
(43) Pub. Date: Nov. 5, 2026

(54) MEASURING APPARATUS, MEASURING METHOD, AND CORRECTING METHOD

(71) Applicant: CANON KABUSHIKI KAISHA, Tokyo (JP)

(72) Inventor: YUKIO FURUKAWA, Kanagawa (JP)

(21) Appl. No.: 19/706,447

(22) Filed: Jun. 12, 2026

Related U.S. Application Data
(63) Continuation of application No. PCT/JP2024/044342, filed on Dec. 16, 2024.

(30) Foreign Application Priority Data
Dec. 18, 2023 (JP) 2023-212822

(51) Int. Cl. G01N 21/64; G01D 5/244

(52) U.S. Cl. CPC G01N 21/6456; G01D 5/244

(57) ABSTRACT

The measuring apparatus includes: a measuring unit configured to acquire measurement information of a target; a scanning unit with a drive source, reciprocally scanning a part of the measuring unit in a first direction; a detection unit acquiring position information that is information regarding a position of the part of the measuring unit; a storage unit storing calibration information for calibrating the position information; a control unit acquiring the measurement information from the measuring unit and the position information from the detection unit in association with each other in response to detection by the detection unit that the part of the measuring unit is at a predetermined position; and a calculation unit generating corrected measurement information by correcting the measurement information, based on the position information and the measurement information associated with each other by the control unit and the calibration information read out from the storage unit.

### CROSS-REFERENCE TO RELATED APPLICATIONS

This application is a Continuation of International Patent Application No. PCT/JP2024/044342, filed Dec. 16, 2024, which claims the benefit of Japanese Patent Application No. 2023-212822, filed Dec. 18, 2023, both of which are hereby incorporated by reference herein in their entirety.

### BACKGROUND

### Field of the Technology

The present disclosure relates to a measuring apparatus, a measuring method, and a correcting method.

### Description of the Related Art

A protein array plate or a peptide array plate in which a large number of biological substances having peptide bonds, such as proteins and peptides, are immobilized on a substrate is known. The use of those array plates enables interactions with a large number of biological substances immobilized on the substrate to be performed at once. Such array plates are effective in comprehensively analyzing interactions between a large number of proteins or peptides and biological liquid specimens, such as blood, cell extracts, saliva, or interstitial fluid. With such analysis, characteristics of a specimen can be measured.

An immobilized site of a sample such as a protein or a peptide on a substrate may hereinafter be referred to as “spot.”

As a method of observing a spot subjected to an interaction with a specimen, there is known, for example, a method of identifying which spot has been subjected to an interaction by labeling the spot with a fluorescent probe. As an apparatus for observing an array plate labeled with a fluorescent probe, a microarray scanner is known (U.S. Patent Application Publication No. 2009/0218513). In U.S. Patent Application Publication No. 2009/0218513, the microarray scanner includes an irradiation optical system, a fluorescence detection optical system, and a two-dimensional scanning system. The irradiation optical system has a function of condensing and applying a laser beam to the array plate. The fluorescence detection optical system has a function of detecting a light amount of fluorescence from a spot labeled with a fluorescent probe. The two-dimensional scanning system has a function of acquiring a fluorescence image of a spot on the array plate by two-dimensionally scanning the array plate or the optical system. One of the two-dimensional scans uses a so-called piston-crank mechanism that converts a rotational motion of an electromagnetic motor into a translational motion, and the irradiation optical system is scanned through use of this mechanism.

In addition, a technology regarding an apparatus and a method for creating a correction table for correcting an error of an encoder for detecting a rotational angular position of an electromagnetic motor is disclosed in Japanese Patent Laid-Open No. 2016-109436.

In a measuring apparatus, position information output by an encoder, which is a detection unit for detecting position information of a measuring unit, may include an error.

Accordingly, inaccurate measurement information is obtained when measurement information is generated through use of the position information of the encoder as a reference. Specifically, a displacement occurs toward a measurement direction. Expansion and contraction occur in the measurement direction when the measurement information to be output is an image.

Particularly when a magnetic encoder is used as the detection unit, noise may be generated when the detection unit passes through a reference mark on a scale, or position accuracy may deteriorate due to fluctuations in a magnetic field caused by a drive source arranged nearby.

In U.S. Patent Application Publication 2009/0218513, it is described that the position of the scanned irradiation optical system is optically measured or calculated from an angle of a shaft connected to an electromagnetic motor. However, there is no recognition of a problem regarding an error of a position measuring unit, and a method of reducing the error is not disclosed as well.

In Japanese Patent Laid-Open No. 2016-109436, a correction table is generated through use of a high-accuracy error detection apparatus. Accordingly, there is a problem in that an apparatus for generating the correction table is separately required. In addition, measurement is required to be performed in advance, and hence it is not possible to cope with a case in which characteristics of the electromagnetic motor change over time, for example.

### SUMMARY

The present disclosure is to provide a measuring apparatus, a measuring method, and a correcting method that eliminate such displacement. In addition, the present disclosure is to provide a measuring apparatus, a measuring method, and a correcting method with which a scanned image in which inaccuracy caused by an error of an encoder for encoding a measurement position of a scanner is reduced can be acquired.

A measuring apparatus according to an embodiment of the present disclosure includes: a measuring unit configured to acquire measurement information of a target; a scanning unit which includes a drive source and is configured to reciprocally scan a part of the measuring unit in a first direction; a detection unit configured to acquire position information that is information regarding a position of the part of the measuring unit; a storage unit configured to store calibration information for calibrating the position information; a control unit configured to acquire the measurement information from the measuring unit and the position information from the detection unit in association with each other in response to detection by the detection unit that the part of the measuring unit is at a predetermined position; and a calculation unit configured to generate corrected measurement information by correcting the measurement information, based on the position information and the measurement information associated with each other by the control unit and the calibration information read out from the storage unit.

A measuring method according to another embodiment of the present disclosure includes: a measurement step of acquiring, through use of a measuring unit, measurement information of a target; a scanning step of reciprocally scanning a part of the measuring unit in a first direction; a detection step of acquiring position information that is information regarding a position of the part of the measuring unit; a storage step of storing calibration information for calibrating the position information; an information acquisition step of acquiring the measurement information from the measuring unit and the position information acquired in the detection step in association with each other in response to detection in the detection step that the part of the measuring unit is at a predetermined position; and a calculation step of generating corrected measurement information by correcting the measurement information, based on the position information and the measurement information associated with each other and the calibration information.

A correcting method according to still another embodiment of the present disclosure includes: a storage step of storing calibration information for calibrating position information that is information regarding a position of a part of a measuring unit; and a calculation step of generating, based on the position information and measurement information and the calibration information, corrected measurement information by correcting the measurement information.

Features of the present disclosure will become apparent from the following description of embodiments with reference to the attached drawings.

### BRIEF DESCRIPTION OF THE DRAWINGS

FIG. 1 is an explanatory flowchart for illustrating a measuring method of the present disclosure.

FIG. 2 is an explanatory flowchart for illustrating a method of acquiring calibration information in the present disclosure.

FIG. 3 is an explanatory diagram for illustrating a measuring apparatus of a first embodiment.

FIG. 4 is an explanatory diagram for illustrating a measuring apparatus of a second embodiment.

FIG. 5 is an explanatory diagram for illustrating a protein array plate.

FIG. 6 is an explanatory diagram for illustrating a fluorescence image of the protein array plate.

FIG. 7A, FIG. 7B, and FIG. 7C are explanatory graphs for showing a displacement in an X direction of a fluorescence image, in which FIG. 7A is a graph for showing a displacement amount of a center-of-gravity position on an outgoing path, FIG. 7B is a graph for showing a displacement amount of the center-of-gravity position on a return path, and FIG. 7C is a graph in which those displacement amounts are displayed in an overlapping manner.

FIG. 8A, FIG. 8B, and FIG. 8C are explanatory graphs for showing position information of an encoder, in which FIG. 8A is a graph for showing an acquisition result of the position information of the encoder, FIG. 8B is a graph for showing a result obtained by performing low-pass filter processing on the acquisition result, and FIG. 8C is a graph for showing a difference between those results.

FIG. 9 is an explanatory graph for showing generation of an error curve from the position information of the encoder.

FIG. 10A and FIG. 10B are explanatory graphs for showing generation of calibration information, in which FIG. 10A is a plot of a relationship between time during scanning and a position of a moving stage, and FIG. 10B is an enlarged graph of a portion surrounded by a square in FIG. 10A.

FIG. 11A and FIG. 11B are explanatory diagrams for illustrating effects of the present disclosure, in which FIG. 11A is an enlarged diagram for illustrating spot portions for upper four rows of a spot image of FIG. 6, and FIG. 11B is an image after correction.

FIG. 12 is an explanatory graph for showing a relationship between a cutoff frequency and an error amount.

FIG. 13 is an explanatory flowchart for illustrating updating of calibration information.

FIG. 14 is an explanatory diagram for illustrating a measuring apparatus of the present disclosure.

FIG. 15 is an explanatory flowchart for illustrating a measuring method of the present disclosure.

FIG. 16 is an explanatory diagram for illustrating a hardware configuration of a control unit.

### DESCRIPTION OF THE EMBODIMENTS

A measuring apparatus according to one embodiment of the present disclosure includes: a measuring unit configured to acquire measurement information of a target; a scanning unit which includes a drive source and is configured to reciprocally scan a part of the measuring unit in a first direction; a detection unit configured to acquire position information that is information regarding a position of the part of the measuring unit; a storage unit configured to store calibration information for calibrating the position information; a control unit configured to acquire the measurement information from the measuring unit and the position information from the detection unit in association with each other in response to detection by the detection unit that the part of the measuring unit is at a predetermined position; and a calculation unit configured to generate corrected measurement information by correcting the measurement information, based on the position information and the measurement information associated with each other by the control unit and the calibration information read out from the storage unit.

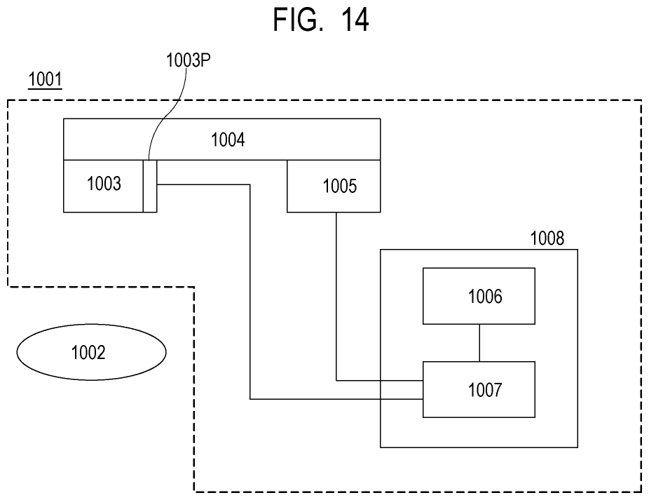

FIG. 14 shows an example of the measuring apparatus of this embodiment. FIG. 14 shows a measuring apparatus 1001, a target 1002, a measuring unit 1003, a part 1003P of the measuring unit, a scanning unit 1004, a detection unit 1005, a storage unit 1006, and a calculation unit 1007. A drive source is not shown. The target 1002 is not included in the measuring apparatus 1001. FIG. 14 shows an example in which the calculation unit 1007 and the storage unit 1006 are included in a control unit 1008, but a control unit for acquiring the measurement information from the measuring unit 1003 and the position information from the detection unit 1005 in association with each other may be arranged separately from the calculation unit 1007 and the storage unit 1006. A hardware configuration of the control unit 1008 is described later.

The detection unit 1005 is an encoder, and specific examples of the encoder include a magnetic encoder and an optical encoder, and also include a rotary encoder and a linear encoder. The encoder performs sampling periodically. The encoder has a reference mark as a reference point, and noise referred to as crosstalk may occur in the vicinity of the reference mark. In addition, when the drive source arranged nearby affects a magnetic field like an electromagnetic motor, the encoder may be affected by the magnetic field to generate an error. According to the measuring apparatus of this embodiment, the crosstalk and the influence of the error of the encoder including the influence of the magnetic field, which are described above, can be reduced.

Thus, according to the measuring apparatus 1001 of this embodiment, highly accurate corrected measurement information can be obtained even when the accuracy of the encoder is not high.

An actuator including an electromagnetic actuator and an ultrasonic vibration type actuator is employed as the drive source. An electromagnetic motor can be employed as the electromagnetic actuator. The scanning unit 1004 can scan the measuring unit 1003 through use of a piston-crank mechanism. The measuring unit 1003 is scanned in one direction (referred to as “first direction”), and the calculation unit 1007 corrects the measurement information in the first direction to generate the corrected measurement information. Further, the measuring unit 1003 can be scanned in a second direction orthogonal to the first direction. In this case, with the calculation unit 1007 acquiring a plurality of pieces of the corrected measurement information in the first direction based on the second direction, two-dimensional corrected measurement information can be generated.

Examples of calibration information indicating a correspondence between the position information and corrected position information include information indicating a correspondence between coordinates of a plurality of points at a predetermined pitch based on the position information output by the detection unit and corrected coordinates of the plurality of points. In this case, the calculation unit can calculate the measurement information at the corrected plurality of points based on the measurement information of the plurality of points at the predetermined pitch based on the position information output by the detection unit to generate the corrected measurement information. A method such as interpolation or extrapolation can be used for this calculation.

The calibration information can be obtained by performing low-pass filter processing on the position information acquired by the detection unit 1005 at a predetermined sampling frequency at a cutoff frequency having a predetermined multiple of a frequency of the drive source. Details of the calibration information are described later. It is preferred that the predetermined multiple be 6.0 or more and 10.0 or less.

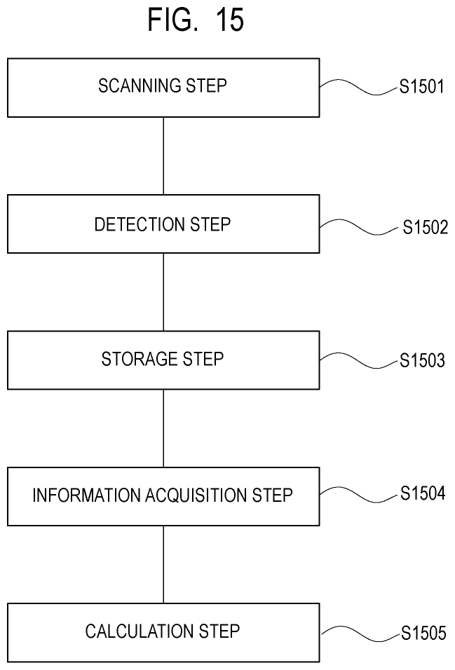

As illustrated in FIG. 15, the measuring method of this embodiment is a measuring method including: a scanning step (Step S1501) of reciprocally scanning a part of a measuring unit in a first direction by the scanning unit 1004 including a drive source (electromagnetic motor 101) to acquire measurement information; a detection step (Step S1502) of acquiring position information that is information regarding a position of the part of the measuring unit; a storage step (Step S1503) of storing calibration information for calibrating the position information; an information acquisition step (Step S1504) of acquiring the measurement information from the measuring unit and the position information acquired in the detection step in association with each other in response to detection in the detection step that the part of the measuring unit is at a predetermined position; and a calculation step (Step S1505) of generating corrected measurement information by correcting the measurement information, based on the position information and the measurement information associated with each other and the calibration information. A measurement step of acquiring measurement information of a target through use of the measuring unit may be performed prior to the scanning step.

In the measuring method of this embodiment, the storage step is executed prior to the scanning step, and the calibration information can be stored in a readable storage unit. In addition, the calibration information stored in the storage unit may be updated in accordance with a higher-level command from an operator.

That is, the calibration information can be stored in advance in the storage unit at any timing, for example, prior to other steps. In this case, the calibration information stored in the storage unit is only required to be used, and it is not required to execute a calibration information acquisition step every time when the measurement information acquisition step is executed a plurality of times.

As another example, a step of calibrating the position information based on the calibration information may be executed every time the detection step is executed. As still another example, the calibration information may be recorded in the storage unit, and when an executor determines that it is required to execute the information acquisition step, the information acquisition step may be executed to update the calibration information in the storage unit. A case in which the executor determines that it is required to execute the information acquisition step includes, for example, a case in which the frequency of the drive source is changed. That is, the calibration information may be updated based on a higher-level command from the executor.

In addition, the correcting method of this embodiment is a correcting method including: a storage step of storing calibration information for calibrating position information that is information regarding a position of a part of a measuring unit; and a calculation step of generating corrected measurement information by correcting the measurement information, based on the position information and measurement information and the calibration information.

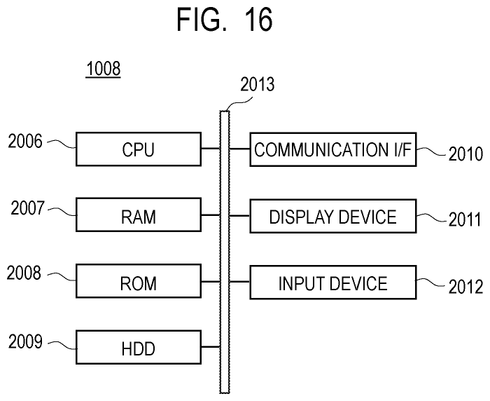

The hardware configuration of the above-mentioned control unit 1008 is described with reference to FIG. 16.

The control unit 1008 has functions of a computer. For example, the control unit 1008 may be configured integrally with a desktop personal computer (PC), a laptop PC, a tablet PC, a smartphone, or the like. In addition, the control unit 1008 may further have a function of controlling other devices in accordance with a predetermined program.

The control unit 1008 includes, in order to implement functions as a computer which performs arithmetic operation and storage, a central processing unit (CPU) 2006, a random-access memory (RAM) 2007, a read-only memory (ROM) 2008, and a hard disk drive (HDD) 2009. The control unit 1008 also includes a communication interface (I/F) 2010, a display device 2011, and an input device 2012. The CPU 2006, the RAM 2007, the ROM 2008, the HDD 2009, the communication I/F 2010, the display device 2011, and the input device 2012 are connected to each other via a bus 2013. The display device 2011 and the input device 2012 may be connected to the bus 2013 via a drive device (not shown) for driving those devices.

In FIG. 16, the components forming the control unit 1008 are illustrated as an integrated device, but some of the functions of those components may be implemented by an external device. For example, the display device 2011 and the input device 2012 may be external devices different from the components implementing the functions of the computer including, for example, the CPU 2006.

The CPU 2006 performs predetermined operations in accordance with programs stored in, for example, the RAM 2007 and the HDD 2009, and also has a function of controlling each component of the control unit 1008. The RAM 2007 is built from a volatile storage medium, and provides a temporary memory area required for the operations of the CPU 2006. The ROM 2008 is built from a non-volatile storage medium, and stores required information such as programs to be used for the operations of the control unit 1008. The HDD 2009 is a storage device which is built from a non-volatile storage medium, and which stores, for example, information on the number of individual independent separate compartments and positions thereof, and fluorescence intensities.

The communication I/F 2010 is a communication interface based on a standard such as Wi-Fi (trademark) or 4G, and is a module for allowing communication to and from another device. The display device 2011 is, for example, a liquid crystal display or an organic light emitting diode (OLED) display, and is used for displaying, for example, moving images, still images, and characters. The input device 2012 is, for example, a button, a touch panel, a keyboard, or a pointing device, and is used by a user to operate the control unit 1008. The display device 2011 and the input device 2012 may be integrally formed as a touch panel.

The hardware configuration illustrated in FIG. 16 is an example, and devices other than the illustrated devices may be added, or some of the illustrated devices may be omitted. Further, some of the devices may be substituted with another device having the same function. Moreover, some of the functions may be provided by another device via a network, and the functions for implementing this embodiment may be shared and implemented by a plurality of devices. For example, the HDD 2009 may be substituted with a solid state drive (SSD) which uses a semiconductor element, such as a flash memory, or may be substituted with cloud storage.

In the following, the present disclosure is described more specifically through use of an example in which a magnetic encoder is used as the detection unit in a system for obtaining the measurement information by applying light to a base material including spots on a glass slide serving as a target, but the present application is not limited to the following example. The present disclosure can be similarly used for a non-optical measuring method. In addition, the detection unit is not limited to the magnetic encoder, and an optical encoder or other encoders may also be used. Particularly when an encoder having a low accuracy is used, the effect of the present disclosure is remarkably obtained.

### First Embodiment

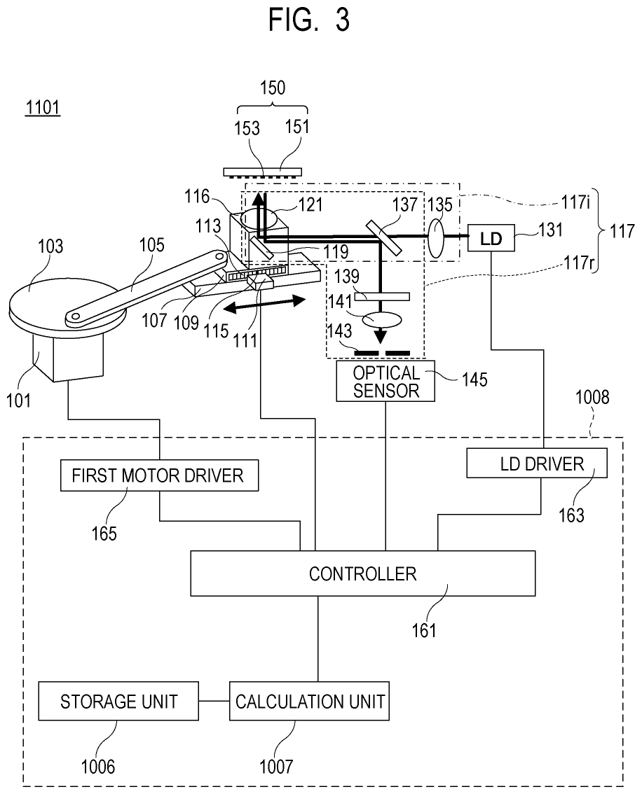

A measuring apparatus 1101 of a first embodiment is described with reference to FIG. 3.

### Scanning Unit

In the measuring apparatus 1101 of this embodiment, the scanning unit 1004 includes the electromagnetic motor 101 serving as the drive source, a disk 103 mounted to the electromagnetic motor 101, a crank 105, a scale 113 including a reference mark 115, a linear guide 107, and a moving stage (X-axis) 109. The crank 105 is rotatably mounted to the disk 103 and the moving stage 109. A support unit 116 for supporting a part of each of an irradiation unit 117i that is an optical system 117 and a light collecting unit 117r that is the optical system 117 is fixed on the moving stage 109. A rotational motion of the electromagnetic motor 101 is converted into a linear reciprocating motion by the disk 103 and the crank 105, and the moving stage 109 linearly moves on the linear guide 107. As a result, it becomes possible to move a focal point of primary light along a base material 151. The moving stage 109 to be guided by the linear guide 107 corresponds to a piston of the piston-crank mechanism.

### Target

In the measuring apparatus 1101 of this embodiment, the target is an array plate 150, and the array plate 150 includes the base material 151 and spots 153. The base material 151 is generally a glass slide. The spots 153 that correspond to a measurement target are arranged on a surface on the glass slide. The spots 153 may be arranged on any one of a front surface or a back surface of the glass slide. The spots 153 includes, for example, specific proteins.

### Measuring Unit

In the measuring apparatus 1101 of this embodiment, the measuring unit 1003 corresponds to a semiconductor laser 131, the irradiation unit 117i, the light collecting unit 117r, the support unit 116 including a part of each of the irradiation unit 117i and the light collecting unit 117r, and an optical sensor 145. The irradiation unit 117i includes an objective lens 121, a 90-degree mirror 119, a dichroic mirror 137, and a collimating lens 135. The light collecting unit 117r includes the objective lens 121, the 90-degree mirror 119, the dichroic mirror 137, a bandpass filter 139, a condensing lens 141, and a pinhole 143. The part 1003P of the measuring unit including the part of each of the irradiation unit 117i and the light collecting unit 117r supported by the support unit 116 includes the objective lens 121, the 90-degree mirror 119, and the scale 113.

### Irradiation Unit

In the measuring apparatus 1101 of this embodiment, the irradiation unit 117i includes the objective lens 121, the 90-degree mirror 119, the dichroic mirror 137, and the collimating lens 135, and is arranged such that primary light is condensed on the surface including the spots 153 on the base material 151.

### Primary Light

Light from the semiconductor laser 131 is converted into parallel light by the collimating lens 135, passes through the dichroic mirror 137, and is applied to the base material 151 via the irradiation unit 117i. This light is the primary light.

Here, the example in which the semiconductor laser is used as a light source has been shown, but an LED may be used.

### Secondary Light

Light emitted from the focal point of the primary light formed on the base material and including information of a specimen or the base material is secondary light. The secondary light is reflected light of the primary light generated on the base material, or a fluorescence of the specimen or the base material emitted by application of the primary light.

### Light Collecting Unit

The light collecting unit 117r includes the objective lens 121, the 90-degree mirror 119, the dichroic mirror 137, the bandpass filter 139, the condensing lens 141, and the pinhole 143, and is an optical system for guiding the secondary light from the focal point to a light detection unit. In this example, an optical member arranged on an optical path that passes through the 90-degree mirror 119 and the objective lens 121 shared by the irradiation unit 117i and the light collecting unit 117r and is reflected by the dichroic mirror 137 corresponds to the light collecting unit 117r.

### Light Detection Unit

The optical sensor 145 detects the secondary light from the light collecting unit. The optical sensor 145 is a photodiode or a photomultiplier tube. The secondary light reflected by the dichroic mirror 137 passes through the bandpass filter 139 and is condensed on the pinhole 143 by the condensing lens 141. Light passing through the pinhole 143 is detected by the optical sensor 145.

### Scanning Unit

In the measuring apparatus 1101 of this embodiment, the scanning unit 1004 includes the electromagnetic motor 101 serving as the drive source, the disk 103, the crank 105, and the scale 113 (reference mark 115). The scanning unit 1004 reciprocally scans the above-mentioned part 1003P of the measuring unit in the first direction.

### Detection Unit

In the measuring apparatus 1101 of this embodiment, the detection unit 1005 is an encoder 111 in FIG. 3. The scale 113 including the reference mark 115 is mounted to the moving stage 109, and the magnetic encoder 111 is fixedly arranged at a position at which information of the scale can be detected. Position information of the moving stage 109 of the scanning unit 1004 can be obtained by the encoder 111. The detection unit 1005 acquires the position information that is information regarding the position of the part 1003P of the measuring unit. In the measuring apparatus 1101 of this embodiment, the position information is Xₙ described below.

### Storage Unit

In the measuring apparatus 1101 of this embodiment, the storage unit 1006 stores calibration information for calibrating the position information. The calibration information is described below.

### Control Unit

In the measuring apparatus 1101 of this embodiment, the control unit 1008 includes a controller 161, an LD driver 163, a first electromagnetic motor driver 165, the storage unit 1006, and the calculation unit 1007. The control unit 1008 acquires an optical information data string “pₙ,” which is the measurement information from the measuring unit 1003, and the position information Xₙ from the encoder 111 in association with each other in response to detection by the encoder 111 that the part 1003P of the measuring unit is at a predetermined position. The controller 161 controls the LD driver 163 and the first electromagnetic motor driver 165, and acquires optical information from the optical sensor 145 through use of the position information of the encoder 111 as a reference for data acquisition.

The LD driver 163 controls the semiconductor laser 131.

The first electromagnetic motor driver 165 controls the electromagnetic motor 101.

The control unit 1008 acquires the position information of the moving stage 109 with the encoder 111, and acquires the optical information of the optical sensor 145 at equal distance intervals based on the position information of the encoder 111 while the moving stage 109 moves from a certain position to another position.

### Calculation Unit

The calculation unit 1007 and the storage unit 1006 are included in a PC. The calibration information is stored in advance in the storage unit 1006. The calculation unit 1007 reads the calibration information from the storage unit 1006, and generates corrected measurement information p_corrₙ by correcting the measurement information, based on the position information Xₙ and the optical information data string “pₙ” being the measurement information which are associated with each other by the control unit 1008, and corrected position information (X_trueₙ) read out from the storage unit 1006.

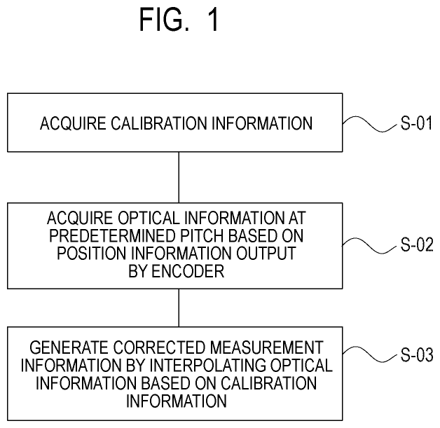

Correction of optical information in the control unit 1008 and the calculation unit 1007 is described with reference to FIG. 1.

### Step S-01: Acquisition of Calibration Information

The calculation unit 1007 reads the calibration information stored in advance from the storage unit 1006. A method of generating the calibration information is described later.

The calibration information is a list of actual positions of the moving stage 109 at a timing of optical information acquisition (more accurately, values that practically have no problem even when being regarded as actual position information of the moving stage 109 excluding error information) when optical information is acquired at equal distance intervals based on the position information of the encoder 111 while the moving stage 109 moves from a certain position to another position.

For example, when the optical information is acquired from −10 mm to +10 mm at intervals of 10 μm, the set position information (Xₙ, “n” is a natural number of from 1 to N) is as follows:
(−10.00, −9.99, −9.98, . . . , 9.99, 10.00).

In contrast, the corrected position information (X_trueₙ) is stored in a format as follows:
(−10.007, −9.991, −9.974, . . . , 9.993, 9.999).

### Step S-02: Acquisition of Pseudo-Equal Pitch Optical Information

The control unit 1008 acquires the optical information of the optical sensor 145 when determining that the moving stage 109 has passed Xₙ based on the position information of the encoder 111. Here, the optical information is an optical information data string “pₙ.” The optical information data string “pₙ” may be referred to as pseudo-equal pitch optical information because the optical information data string “pₙ” has a substantially equal pitch.

### Step S-03: Acquisition of Equal Pitch Optical Information

The corrected measurement information (p_corrₙ) is generated by interpolating the optical information based on the corrected position information X_trueₙ.

The corrected measurement information (p_corrₙ) is generated by interpolating or extrapolating a data set of (Xₙ, p_corrₙ) from a data set of (X_trueₙ, pₙ).

As an interpolation method, an appropriate method such as nearest neighbor interpolation, linear interpolation of two adjacent points, polynomial interpolation of multiple adjacent points, and spline interpolation may be selected.

Generation of the calibration information is described.

### (a) Position Information Obtained by Detection Unit

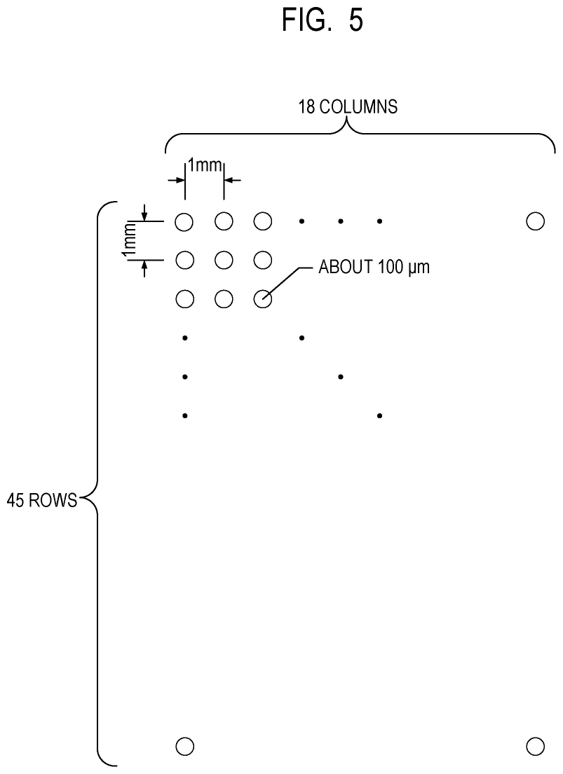

Protein array spots of 18 columns and 45 rows illustrated in FIG. 5 are prepared. Each spot includes a protein BCAR1. The protein BCAR1 is tagged with glutathione S-transferase (GST), and the GST tag is labeled with a fluorescent probe for emitting fluorescence with respect to light having a wavelength of 670 nm. The size of each spot is about 100 μm, and the pitch is 1 mm in both of vertical and horizontal directions.

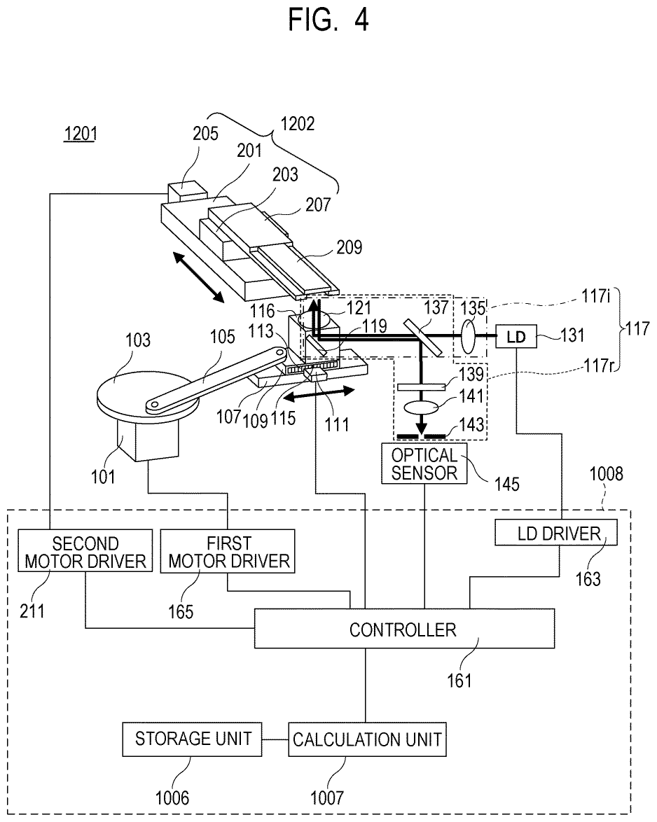

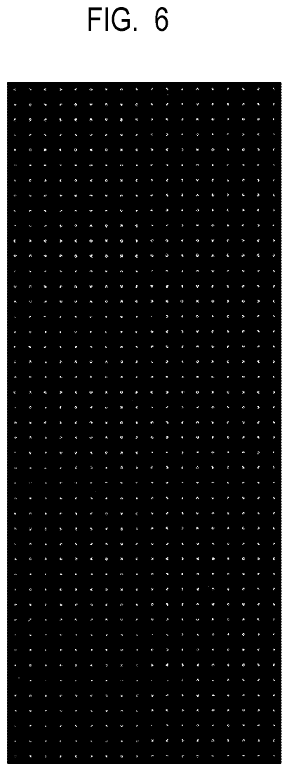

FIG. 6 shows an example in which a two-dimensional image of such a protein array spot is acquired by the measuring apparatus illustrated in FIG. 4 (details thereof are described later). Here, a rotation speed of the electromagnetic motor 101 is 1,200 rpm (=20 rps), a distance from an electromagnetic motor shaft to a connection portion of the crank 105 is 15 mm, a length of the crank 105 is 100 mm, and the moving stage 109 is scanned by 30 mm from −15 mm to +15 mm.

A scan in a direction in which the moving stage 109 moves away from the electromagnetic motor 101 is referred to as “outgoing path,” and a scan in a direction in which the moving stage 109 approaches the electromagnetic motor 101 is referred to as “return path.”

The image shown in FIG. 6 is an image of the optical information acquired only on the outgoing path, and correction using the calibration information is not performed.

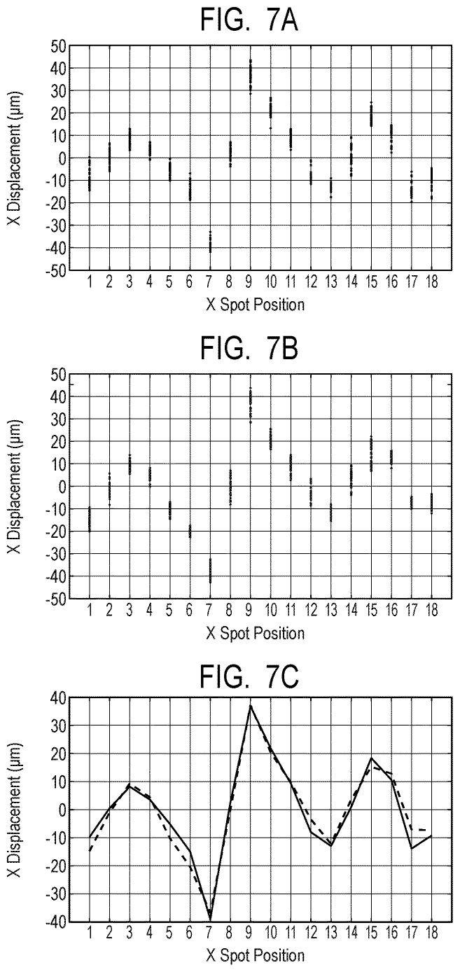

FIG. 7A shows results of measuring how much a center-of-gravity position of the spot is displaced from a correct position from the image of FIG. 6. An X direction is a direction in which the moving stage 109 is scanned. Here, the horizontal axis represents a column number of the protein array spot, and the vertical axis represents a displacement amount in the X direction. Data of 45 points exists for each column. The reference mark is arranged between a seventh column and a ninth column, and positive and negative of an error direction are reversed around the reference mark. In addition, an error occurs also at a place other than the reference mark.

Similarly, FIG. 7B shows results of measuring how much the center-of-gravity position of the spot is displaced from the correct position for an image of the optical information acquired only on the return path. FIG. 7B shows the same tendency as that of FIG. 7A.

FIG. 7C shows FIG. 7A and FIG. 7B in an overlapping manner after averaging is performed for each column number. Here, the solid line indicates the displacement amount of the image only on the outgoing path, and the dotted line indicates the displacement amount of the image only on the return path. The solid line and the dotted line match each other well, and hence it can be seen that this phenomenon does not depend on a scanning direction (whether the scanning direction is the outgoing path or the return path). This means that an image including an error in the X direction is obtained in the same manner even when the optical information during two-dimensional scanning is acquired on both of the outgoing path and the return path to form one image.

### (b) Regarding Calibration Information

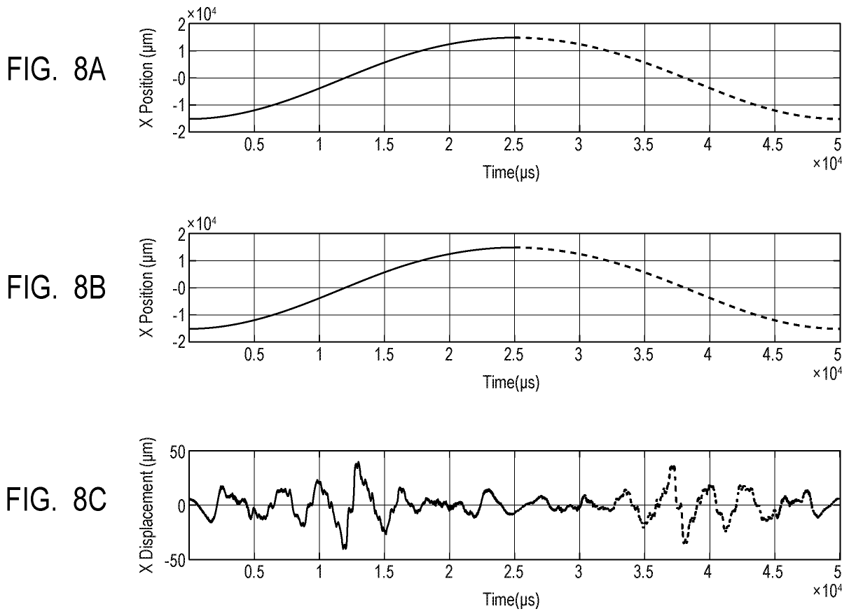

FIG. 8A shows results of acquiring the position information of the encoder 111 at a sampling interval (sampling frequency) of 1 μs (1 MHz) when the electromagnetic motor 101 is driven at a rotation speed of 1,200 rpm in the measuring apparatus illustrated in FIG. 4. The horizontal axis represents time, and the vertical axis represents position information. In FIG. 8A to FIG. 8C, the outgoing path is indicated by the solid line, and the return path is indicated by the dotted line.

FIG. 8B shows results of performing low-pass filter processing on the results of FIG. 8A through use of 180 Hz, which is a frequency nine times the rotation speed, as the cutoff frequency.

Further, results obtained by subtracting the results of FIG. 8B from the results of FIG. 8A are shown in FIG. 8C. This is equal to results obtained by performing high-pass filter processing on the results of FIG. 8A through use of 180 Hz, which is a frequency nine times the rotation speed, as a cut-on frequency.

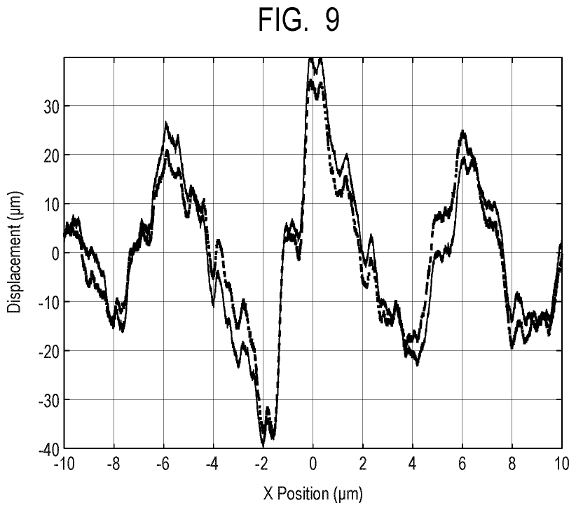

Here, the inventor of the present application has found that the results of FIG. 7C can be expressed when the position information of FIG. 8B is assumed to be a correct value and the position information of FIG. 8C is assumed to be an error amount. That is, the inventor of the present application has found that FIG. 9 is obtained by plotting the position information of FIG. 8B on the horizontal axis and the position information of FIG. 8C on the vertical axis, and the results of FIG. 7C match those of FIG. 9 well.

### (c) Method of Acquiring Calibration Information

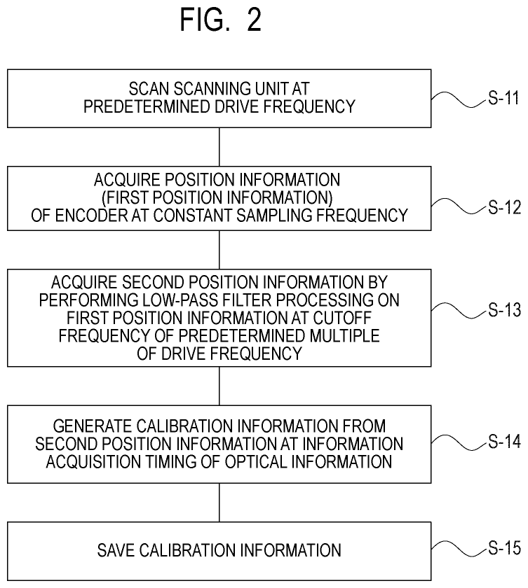

The method of acquiring the calibration information derived from this finding is described with reference to FIG. 2.

### Step S-11: Driving of Scanning Unit

The scanning unit 1004 is scanned at a predetermined drive frequency. The drive frequency matches the rotation speed of the electromagnetic motor 101.

### Step S-12: Acquisition of First Position Information

The position information (first position information) of the encoder 111 is acquired at a constant sampling frequency. The sampling frequency may be set to an appropriate value in accordance with subsequent steps and the pitch of the optical information desired to be acquired.

### Step S-13: Acquisition of Second Position Information

Second position information is acquired by performing low-pass filter processing on the first position information at a cutoff frequency of a predetermined multiple of the drive frequency. Here, it is appropriate that the predetermined multiple be approximately from 6.0 to 10.0 (described later).

### Step S-14: Generation of Calibration Information

The calibration information is generated from the second position information at the information acquisition timing of the optical information.

In the above-mentioned example, when the optical information is acquired from −10 mm to +10 mm at intervals of 10 μm, a time at which the encoder 111 indicates the following set position information (Xₙ, “n” is a natural number of from 1 to N) is the information acquisition timing of the optical information:
(−10.00, −9.99, −9.98, . . . , 9.99, 10.00).

In addition, the following second position information at the timing is the corrected position information (X_trueₙ):
(−10.007, −9.991, −9.974, . . . , 9.993, 9.999).

### Step S-15: Saving of Calibration Information

The generated calibration information is stored in the storage unit 1006.

### (d) Supplementary Description of Calibration Information

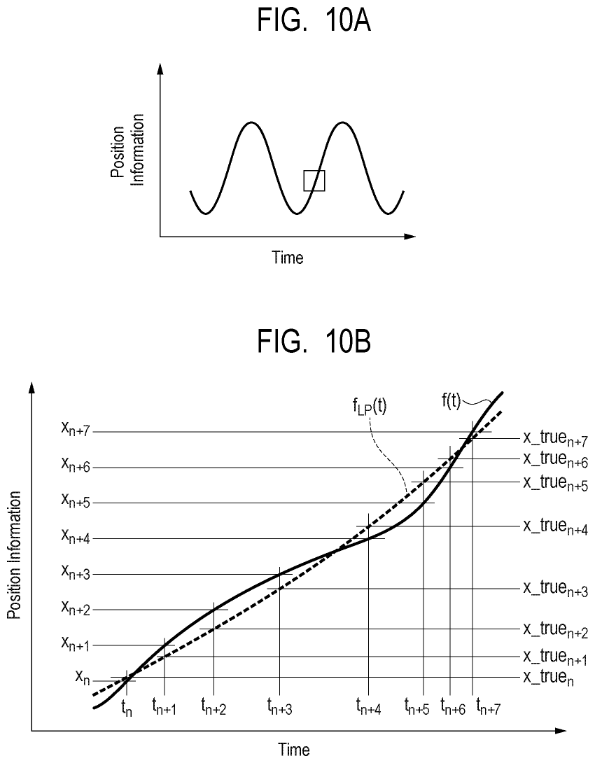

Step S-14 (generation of calibration information) is further described with reference to FIG. 10A and FIG. 10B.

FIG. 10A is a plot of a relationship between time during scanning and the position of the moving stage. FIG. 10B is an enlarged graph of a portion surrounded by a square in FIG. 10A. In addition, the solid line of FIG. 10B is position information f(t) measured by the encoder 111, and the dotted line is position information f_{LP}(t) obtained by performing low-pass filter processing on the position information f(t).

The optical information is acquired at predetermined positions of from Xₙ to Xₙ₊₇, and the corresponding times are from “tₙ” to tₙ₊₇.

The corrected position information X_trueₙ can be obtained as follows:

X_trueₙ=f_{LP}(tₙ).

Effects of the correction are described.

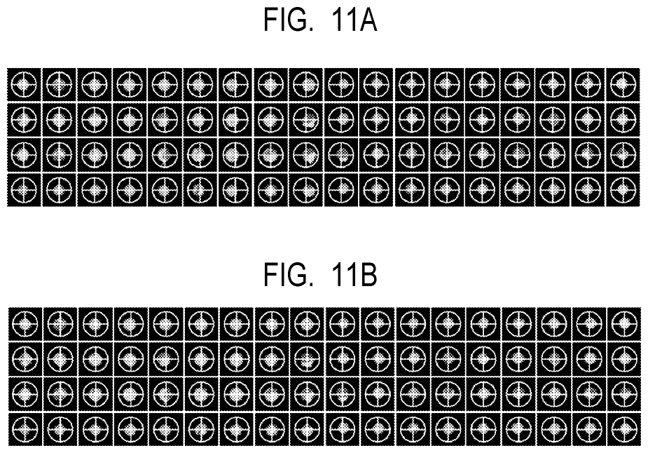

FIG. 11A is an enlarged diagram for illustrating spot portions for upper four rows of the spot image of FIG. 6. Circle lines and cross lines indicate regions of interest having a vertical and horizontal pitch of 1 mm. It can be seen that there is a spot displaced to the left or right with respect to the region of interest because correction is not performed here.

FIG. 11B is an image subjected to correction. The effect of the correction can be seen because the spot image is located substantially in the center with respect to the region of interest.

A method of determining a cutoff frequency is described.

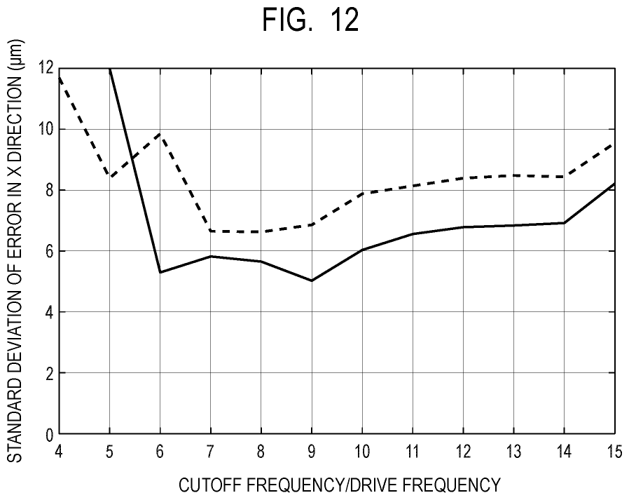

FIG. 12 shows a ratio of the cutoff frequency with respect to a drive frequency on the horizontal axis, and a standard deviation of error amounts in the X direction for all of 18×45 spots on the vertical axis. In addition, the solid line is for optical information acquired only on the outgoing path, and the dotted line is for optical information acquired only on the return path.

From FIG. 12, it can be seen that the standard deviation of the error amounts can be reduced when the cutoff frequency is from 6 times to 10 times the drive frequency. Accordingly, it is appropriate that the cutoff frequency be equal to or more than 6.0 times the drive frequency and equal to or less than 10.0 times the drive frequency.

A specific example of measurement is described with reference to FIG. 3.

Description of parts that overlap with the above description is omitted.

### Primary Light

The semiconductor laser 131 emits laser light having a wavelength of 670 nm and an output of 5 mW. The laser light is converted into parallel light by the collimating lens 135, passes through the dichroic mirror 137, and is condensed on the surface including the spots 153 by the objective lens 121.

### Secondary Light

Fluorescence, which is secondary light, is generated by applying the primary light to the spots 153.

### Light Collecting Unit

The secondary light is reflected by the dichroic mirror 137, passes through the bandpass filter 139 having a passband of from 695 nm to 730 nm, and is condensed on the pinhole 143 by the condensing lens 141.

### Light Detection Unit

The optical sensor 145 includes a photomultiplier tube so as to be able to detect weak secondary light.

In the measuring apparatus of this embodiment, calibration information is measured in advance and is stored in the storage unit 1006.

### Step S-01: Acquisition of Calibration Information

The calculation unit 1007 reads the calibration information stored in advance from the storage unit 1006.

For example, the corrected position information (X_trueₙ) is as follows:
(−10.007, −9.991, −9.974, . . . , 9.993, 9.999).

### Step S-02: Acquisition of Pseudo-Equal Pitch Optical Information

The controller 161 included in the control unit 1008 acquires position information of the moving stage 109 through use of the encoder 111, and acquires optical information of the optical sensor 145 at equal distance intervals based on the position information of the encoder 111 while the moving stage 109 moves from a certain position (position A) to another position (position B). The position A, the position B, and the distance interval of optical information acquisition are set in advance so as to match the calibration information acquired in advance. The set position information (Xₙ, “n” is a natural number of from 1 to N) is as follows:
(−10.00, −9.99, −9.98, . . . , 9.99, 10.00).

An optical information data string is defined as “pₙ.”

### Step S-03: Acquisition of Equal Pitch Optical Information

Corrected measurement information (p_corrₙ) is generated by interpolating the optical information based on the calibration information.

That is, the corrected measurement information is generated by interpolating or extrapolating a data set of (Xₙ, p_corrₙ) from a data set of (X_trueₙ, pₙ).

According to this embodiment, equal pitch optical information in which an error of the position information of the magnetic encoder 111 caused by a reference mark or other factors is reduced can be acquired.

### Second Embodiment

A second embodiment is described with reference to FIG. 4. A measuring apparatus 1201 of this embodiment is different from the measuring apparatus 1101 of the first embodiment in that the measuring unit 1003 includes a sub-scanning unit 1202 for performing scanning in a second direction intersecting with the first direction.

### Placing Unit

A placing unit 207 is configured to be able to hold the array plate 150. In this example, a part of the placing unit 207 is hollowed out so that the primary light can be applied from a back surface side.

### Sub-Scanning Unit

The sub-scanning unit 1202 is also referred to as “second scanning unit.” In the measuring apparatus of this embodiment, the sub-scanning unit 1202 includes a linear guide 201, a moving stage (Y-axis) 203, an electromagnetic motor 205, the placing unit 207, and a support table 209. The moving stage 203 moves on the linear guide 201 when the electromagnetic motor 205 is rotated. The moving stage 203 includes the support table 209, and the placing unit 207 which is supported by the support table 209 and on which the array plate 150 is placed. As a result, it becomes possible to scan a base material in a direction intersecting with a scanning direction of a first scanning unit. A pulse electromagnetic motor is suitable as the electromagnetic motor 205 because high accuracy is required for scanning in this direction.

### Control Unit

The control unit 1008 includes the controller 161, the LD driver 163, the first electromagnetic motor driver 165, a second electromagnetic motor driver 211, the storage unit 1006, and the calculation unit 1007. The controller 161 controls the LD driver 163, the first electromagnetic motor driver 165, and the second electromagnetic motor driver 211, and acquires the optical information from the optical sensor 145 through use of the position information of the encoder 111 as a reference for data acquisition.

The LD driver 163 controls the semiconductor laser 131.

The first electromagnetic motor driver 165 controls the electromagnetic motor 101.

The second electromagnetic motor driver 211 controls the electromagnetic motor 205.

The control unit acquires the position information of the moving stage 109 through use of the encoder 111, and acquires the optical information of the optical sensor 145 at equal distance intervals based on the position information of the encoder 111 while the moving stage 109 moves from a certain position to another position.

Further, the control unit controls the sub-scanning unit to scan the base material 151 in a direction orthogonal to the scanning direction of the moving stage 109.

According to this embodiment, it becomes possible to acquire the optical information from the array plate 150 two-dimensionally, and an optical information image in which the error of the position information of the magnetic encoder 111 caused by the reference mark or other factors is reduced can be acquired.

### Third Embodiment

In the first embodiment and the second embodiment, the calibration information is acquired in advance prior to measurement. A third embodiment is different from the measuring apparatus 1101 of the first embodiment and the measuring apparatus 1201 of the second embodiment in that the calibration information is updated for each measurement and is stored in the storage unit 1006.

For example, when it is desired to acquire data at a finer pitch or it is desired to perform scanning at a lower drive frequency in accordance with a measurement target, it is appropriate to update the calibration information in accordance with those conditions.

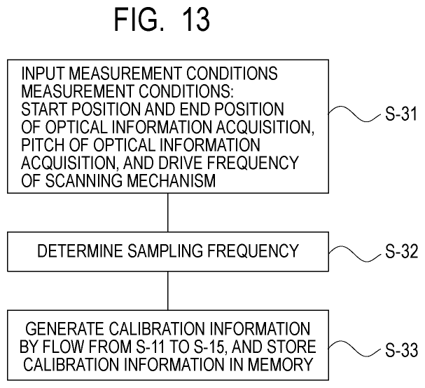

In that case, a flow described below is adopted (see FIG. 13).

### Step S-31: Input of Measurement Conditions

An operator inputs measurement conditions. The measurement conditions include a start position and an end position of optical information acquisition, a pitch of optical information acquisition, and a drive frequency of the scanning unit 1004.

### Step S-32: Determination of Sampling Frequency

A sampling frequency is determined from the pitch of optical information acquisition and the drive frequency of the scanning unit 1004. It is desired that a sampling time interval be equal to or less than a time required for moving a distance corresponding to the optical information acquisition pitch when the moving stage moves at the highest speed. As another example, a sufficiently high sampling frequency may be fixed and given.

### Step S-33: Generation and Saving of Calibration Information

The calibration information is generated by a flow from Step S-11 to Step S-15, and is stored in a memory.

According to this embodiment, even when the measurement conditions are changed, the optical information image in which the error of the position information is reduced can be acquired by acquiring the optimal calibration information.

### Fourth Embodiment

In a fourth embodiment, the calibration information is updated in accordance with a higher-level command from an executor.

There is a possibility that an error amount of the position information acquired by the encoder 111 changes due to a change over time of the linear guide or the electromagnetic motor. The calibration information may be able to be updated at a timing desired by the executor so as to cope with such a case.

### Other Embodiments

The calibration information may be provided for each of the outgoing path and the return path, and correction may be performed independently on the outgoing path and the return path. As another example, characteristics substantially match between the outgoing path and the return path, and hence only one of the calibration information for the outgoing path or the calibration information for the return path may be adopted and applied to both the outgoing path and the return path, or an average value thereof may be adopted.

According to the measuring apparatus of the present disclosure, it is possible to provide a measuring apparatus, a measuring method, and a correcting method with which a scanned image in which inaccuracy caused by an error of an encoder for encoding a measurement position of a scanner is reduced can be obtained.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

1. A measuring apparatus comprising:
a measuring unit configured to acquire measurement information of a target;
a scanning unit which includes a drive source and is configured to reciprocally scan a part of the measuring unit in a first direction;
a detection unit configured to acquire position information that is information regarding a position of the part of the measuring unit;
a storage unit configured to store calibration information for calibrating the position information;
a control unit configured to acquire the measurement information from the measuring unit and the position information from the detection unit in association with each other in response to detection by the detection unit that the part of the measuring unit is at a predetermined position; and
a calculation unit configured to generate corrected measurement information by correcting the measurement information, based on the position information and the measurement information associated with each other by the control unit and the calibration information read out from the storage unit.

2. The measuring apparatus according to claim 1,
wherein the detection unit includes an encoder configured to encode the position information, and
wherein the scanning unit includes a scale on which the encoder detects the position information.

3. The measuring apparatus according to claim 2, wherein the encoder includes a magnetic encoder.

4. The measuring apparatus according to claim 1, wherein the drive source includes an electromagnetic actuator.

5. The measuring apparatus according to claim 1, wherein the scanning unit includes a piston-crank mechanism including a crank connected to the drive source and a piston connected to the part of the measuring unit, and is configured to scan the part of the measuring unit via the piston-crank mechanism.

6. The measuring apparatus according to claim 1,
wherein the storage unit is configured to acquire a plurality of pieces of measurement information acquired by the measuring unit, and
wherein the calculation unit is configured to select at least one piece of measurement information among the plurality of pieces of measurement information from the storage unit based on the position information and the calibration information, and generate the corrected measurement information based on the selected at least one piece of measurement information.

7. The measuring apparatus according to claim 5, further comprising:
a sub-scanning unit configured to scan the part of the measuring unit for the target in a second direction intersecting with the first direction; and
a placing unit on which the target is to be placed,
wherein the sub-scanning unit is configured to move the placing unit in the second direction with respect to the scanning unit.

8. The measuring apparatus according to claim 7, wherein the calculation unit is configured to generate two-dimensional measurement information based on the corrected measurement information, the position information, and information regarding a position of the part of the measuring unit in the second direction.

9. The measuring apparatus according to claim 1, wherein the measuring unit includes an irradiation unit configured to apply light to the target, and a light collecting unit configured to collect light from the target.

10. The measuring apparatus according to claim 1, wherein the calibration information includes information corresponding to position information obtained by subjecting the position information acquired by the control unit via the detection unit to filter processing through use of a low-pass filter having a cutoff frequency corresponding to a predetermined multiple of a frequency of the reciprocal scanning by the scanning unit.

11. The measuring apparatus according to claim 10, wherein the predetermined multiple is 6.0 or more and 10.0 or less.

12. The measuring apparatus according to claim 1, wherein the calibration information is stored in the storage unit such that a data set including a plurality of pieces of the position information acquired from the detection unit by the control unit so as to correspond to a plurality of predetermined positions and a data set including a plurality of pieces of corrected position information obtained by correcting the plurality of pieces of the position information by the calculation unit are associated with each other.

13. A measuring method comprising:
a measurement step of acquiring, through use of a measuring unit, measurement information of a target;
a scanning step of reciprocally scanning, by a scanning unit including a drive source, a part of the measuring unit in a first direction;
a detection step of acquiring, through use of a detection unit, position information that is information regarding a position of the part of the measuring unit;
a storage step of storing calibration information for calibrating the position information;
an information acquisition step of acquiring the measurement information from the measuring unit and the position information acquired in the detection step in association with each other in response to detection in the detection step that the part of the measuring unit is at a predetermined position; and
a calculation step of generating corrected measurement information by correcting the measurement information, based on the position information and the measurement information associated with each other and the calibration information.

14. The measuring method according to claim 13, wherein the storage step is executed prior to the measurement step, and the calibration information is stored in a readable storage unit.

15. The measuring method according to claim 14, wherein the calibration information stored in the readable storage unit is updated in accordance with a higher-level command from an executor.

16. The measuring method according to claim 13, wherein the calibration information includes information corresponding to position information obtained by subjecting the position information acquired in the detection step to filter processing through use of a low-pass filter having a cutoff frequency corresponding to a predetermined multiple of a frequency of the reciprocal scanning in the scanning step.

17. The measuring method according to claim 16, wherein the predetermined multiple is 6.0 or more and 10.0 or less.

18. The measuring method according to claim 13, wherein the calibration information is stored in the storage step such that a data set including a plurality of pieces of the position information acquired in the detection step so as to correspond to a plurality of predetermined positions and a data set including a plurality of pieces of corrected position information generated in the calculation step and obtained by correcting the plurality of pieces of the position information are associated with each other.

19. A correcting method comprising:
a storage step of storing calibration information for calibrating position information that is information regarding a position of a part of a measuring unit; and
a calculation step of generating, based on the position information and measurement information and the calibration information, corrected measurement information by correcting the measurement information.
